(19) United States
(12) Patent Application Publication
(10) Pub. No.: US 2026/0080637 A1
(43) Pub. Date: Mar. 19, 2026

(54) INFORMATION PROCESSING SYSTEM MANAGING DATA FOR EXECUTING PROCESSING BASED ON INPUT INFORMATION FROM USER, CONTROL METHOD OF INFORMATION PROCESSING SYSTEM, AND NON-TRANSITORY COMPUTER READABLE MEDIUM

(71) Applicant: CANON KABUSHIKI KAISHA, Tokyo (JP)

(72) Inventor: Hikaru UCHIDATE, Kanagawa (JP)

(21) Appl. No.: 19/329,566

(22) Filed: Sep. 16, 2025

(30) Foreign Application Priority Data
Sep. 18, 2024 (JP) 2024-161002

(51) Int. Cl. G06T 19/00; G06F 3/01

(52) U.S. Cl. CPC G06T 19/006; G06F 3/013

(57) ABSTRACT

An information processing system includes one or more processors and/or circuitry configured to: execute generation processing for generating a virtual image by rendering a virtual object based on a reference position determined at a first time; execute combining processing for generating a display image by combining the virtual image and a first image; execute display control processing for displaying the display image on a display at a second time; execute input processing for acquiring input information from a user for the display at the second time; and execute control processing in which the input information, the display image, information about the reference position, first piece of information which is time information related to the reference position, and second piece of information which is time information related to the first image, are correlated with each other and stored in a storage device.

### BACKGROUND

### Field of the Technology

The present disclosure relates to an information processing system, a control method of an information processing system, and a non-transitory computer readable medium.

### Description of the Related Art

In recent years, a so-called mixed reality (MR) technology has become known as a technology that seamlessly fuses a real space and the virtual space in real time. Among MR technologies, a technology that involves the use of a video see-through-type head mounted display (HMD) to display an image in which computer graphics (CG) are superimposed on a captured image of the real space has become known.

Presently, there is a technology that detects the line-of-sight direction of a user by using a camera capturing the pupils of a user, and identifies the observation position of the user in a display image. In addition, a function such as line-of-sight log for storing the movement of the position viewed by the user in a display image by storing the display image and the observation position of the HMD has also become known. In order to achieve the function of line-of-sight log, it is necessary to correlate an object in the display image with the line-of-sight detection position with high accuracy. In Japanese Patent Laid-Open No. 2021-43368, a method for identifying, on the basis of a drive mode set from among an image capturing drive mode and a display drive mode, a display image used for line-of-sight detection and a line-of-sight detection result is described.

In the function of line-of-sight log, an object, which is observed by a user, in an MR image in which a captured image of the real space and CG are fused is obtained by scoring and weighting. In this case, it is necessary to identify with high accuracy whether the user is observing the real region or the CG region, and at which point in time the real image and the CG image are being observed. However, normally, there is a difference between the time when the real image is generated and the time when the CG image is generated, which images are used for an MR image.

In Japanese Patent Laid-Open No. 2021-43368, although the display image and the line-of-sight detection result can be identified, information of the object displayed in the display image is not identified. That is, it is difficult to identify whether the user is observing the real space or the CG. Consequently, it is difficult to manage data in such a way that processing based on input information, such as a line-of-sight detection result, can be appropriately executed.

### SUMMARY

The present disclosure provides a technique for managing data in such a way that processing corresponding to input information regarding a display image can be executed more appropriately.

One embodiment of the present disclosure is an information processing system including: one or more processors and/or circuitry configured to: execute generation processing for generating a virtual image by rendering a virtual object based on a reference position determined at a first time; execute combining processing for generating a display image by combining the virtual image and a first image; execute display control processing for displaying the display image on a display at a second time; execute input processing for acquiring input information from a user for the display at the second time; and execute control processing in which the input information, the display image, information about the reference position, first piece of information which is time information related to the reference position, and second piece of information which is time information related to the first image, are correlated with each other and stored in a storage device.

One embodiment of the present disclosure is a control method of an information processing system including: generating a virtual image by rendering a virtual object based on a reference position determined at a first time; generating a display image by combining the virtual image and a first image; displaying the display image on a display at a second time; acquiring input information from a user for the display at the second time; and executing control processing in which the input information, the display image, information about the reference position, first piece of information which is time information related to the reference position, and second piece of information which is time information related to the first image, are correlated with each other and stored in a storage device.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of an information processing system according to a first embodiment.

FIG. 2 is a configuration diagram of an HMD and a generation device according to the first embodiment.

FIG. 3A to FIG. 3F are flow charts showing processing according to the first embodiment.

FIG. 4 is a time chart showing the processing at each time according to the first embodiment.

FIG. 5A and FIG. 5B are flow charts showing processing according to a second embodiment.

FIG. 6 is a diagram for explaining re-projection processing according to a third embodiment.

FIG. 7 is a flow chart showing processing of a log storage unit according to the third embodiment.

### DESCRIPTION OF THE EMBODIMENTS

Hereinafter, embodiments of the present disclosure will be described in detail with reference to the accompanying drawings.

### First Embodiment

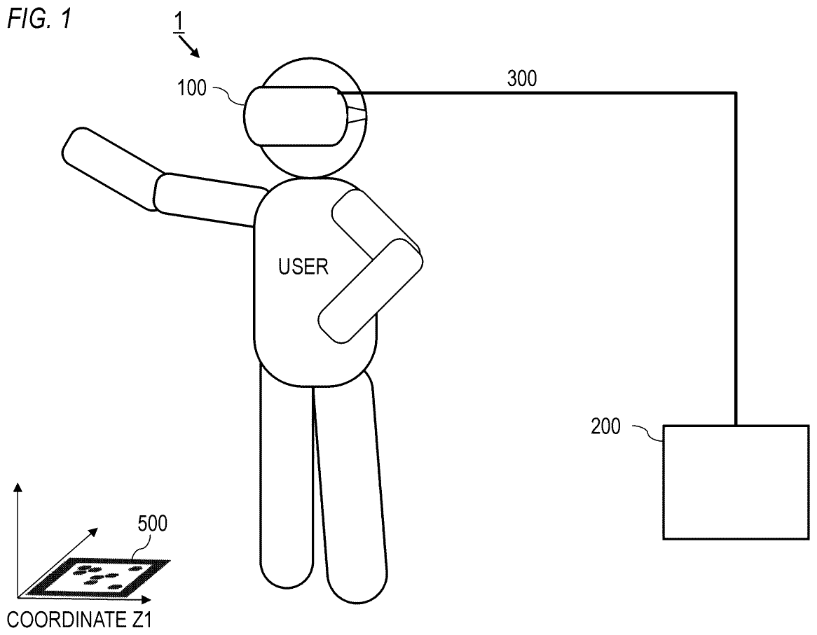

FIG. 1 is a diagram showing a system configuration according to a first embodiment. In FIG. 1, an information processing system 1 includes a head-mounted type image display device (Head Mounted Display, hereinafter referred to as “HMD”) 100, and a generation device 200.

The HMD 100 is worn by a user on the head. The HMD 100 allows the user to experience mixed reality (MR) by displaying an image on an indication display.

The HMD 100 captures the real space with a camera arranged outwardly to acquire a real image. The HMD 100 displays, on the indication display, an image in which a virtual image generated by the generation device 200 and the real image are combined, as an MR image.

The generation device 200 generates a virtual image that is an image of the virtual space experienced by the user using the HMD 100. Specifically, the generation device 200 renders the virtual image by calculating the rendering position of a virtual object on the basis of the real image and tracking data. In order to obtain an appropriate position of the virtual object in the real space, a method for detecting, from the real image, the position (marker position) of a marker 500 arranged in the real space is used. As a result, the virtual image in which the virtual object corresponding to a “coordinate Z1” uniquely determined with reference to the marker 500 placed on the floor is arranged is generated, and an MR image in which the virtual image and the real image are combined is generated.

The generation device 200 is, for example, an information processing device such as a PC (Personal Computer). The generation device 200 may be connected to a server via a network. In addition, the generation device 200 may be a portable device that can be carried in a set with the HMD 100.

An interface 300 connects the HMD 100 and the generation device 200 through a wired cable. In this way, the HMD 100 and the generation device 200 exchange data with each other. The data to be exchanged is not limited to image data, but also includes sensor data (data acquired by an acceleration sensor or an angular velocity sensor), audio data, control data for controlling the HMD 100, and the like. In addition, in the first embodiment, the interface 300 is an interface that realizes connection in a wired manner, but it may also be an interface that realizes connection in a wireless manner.

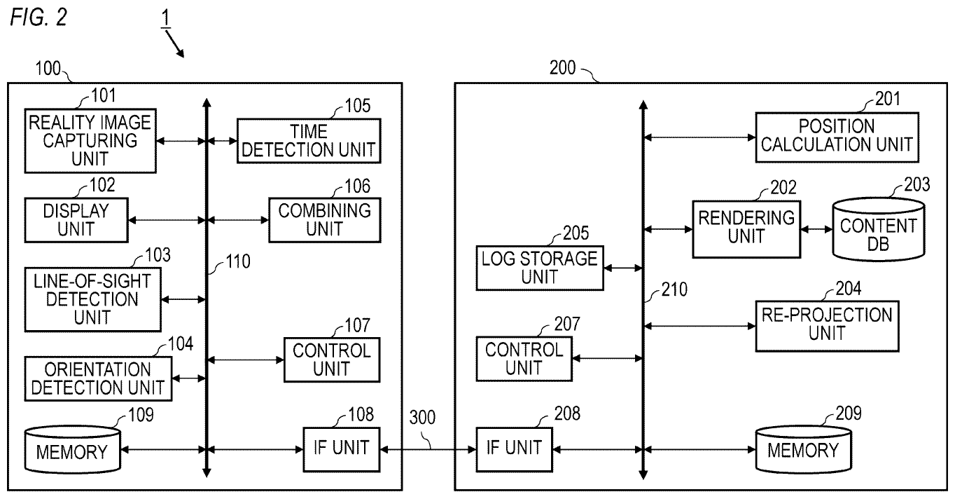

FIG. 2 is a configuration diagram of the HMD 100 and the generation device 200 shown in FIG. 1. As shown in FIG. 2, the HMD 100 includes a reality image capturing unit 101, a display unit 102, a line-of-sight detection unit 103, an orientation detection unit 104, a time detection unit 105, a combining unit 106, a control unit 107, an interface unit (IF unit) 108, and a memory 109. These components are connected via a system bus 110.

The reality image capturing unit 101 acquires a real image by capturing the real space. The reality image capturing unit 101 sends the real image to the generation device 200 and the combining unit 106.

The display unit 102 displays an MR image (mixed reality image) generated by the combining unit 106. This allows the user to visually confirm the MR image.

The line-of-sight detection unit 103 determines the movement of the pupils (eyes) on the basis of an image obtained by capturing the pupils of the user with a camera. The line-of-sight detection unit 103 identifies the line-of-sight direction of the user on the basis of the movement of the pupils. The information about the identified line-of-sight direction is taken in as gaze point information (viewpoint information) of the user viewing the display unit 102, and is sent to the generation device 200 via the interface unit 108. Since the method for line-of-sight detection is generally known, the description thereof will be omitted. Note that the information about the position viewed by the user on a display surface of the display unit 102 may be detected and taken as the gaze point information by the line-of-sight detection unit 103.

The orientation detection unit 104 acquires the orientation of the HMD 100. The information about the acquired orientation is taken in as position/orientation information indicating the movement of the HMD 100, and is sent to the generation device 200 via the interface unit 108.

The time detection unit 105 manages the acquisition time for information acquired by each component. In the first embodiment, a method for generating time stamp information inside the HMD 100 for time management and identifying the acquisition time of each function is described. The acquired time information is sent to the generation device 200 via the interface unit 108 together with data acquired by each function.

The combining unit 106 combines the real image acquired by the reality image capturing unit 101 and the virtual image sent from the generation device 200 to generate an MR image. The generated MR image is sent to the display unit 102 and displayed on the display unit 102.

The control unit 107 is an arithmetic processing device such as a central processing unit (CPU). The control unit 107 manages the operations, sequences and the like of each function.

Note that the HMD 100 may be composed of an information processing device (display control device) that includes the reality image capturing unit 101, the display unit 102, and other components. In this case, the control unit 107 included in the information processing device functions as a display control unit that controls the display on the display unit 102, and also functions as an image capturing control unit that controls the image capturing of the reality image capturing unit 101. In addition, the HMD 100 may have all or part of the configuration of the generation device 200.

As shown in FIG. 2, the generation device 200 includes a position calculation unit 201, a rendering unit 202, a content DB 203, a re-projection unit 204, a log storage unit 205, a control unit 207, an interface unit (IF unit) 208, and a memory 209. These components are connected to each other via a system bus 210.

The position calculation unit 201 recognizes the marker 500 of the real space from the real image acquired by the reality image capturing unit 101. Then, the position calculation unit 201 detects the “coordinate Z1” (position) of the marker 500 in a camera coordinate system with the position/orientation of the HMD 100 as a reference. In addition, the position calculation unit 201 detects the position and orientation of the HMD 100 in the real space in order to more accurately arrange the virtual image in the image viewed by the user of the HMD 100. The position calculation unit 201 may detect, by means of a tracking system arranged in the real space, an optical sensor attached to the HMD 100, and detect the relative position/orientation of the HMD 100. The position calculation unit 201 is not particularly limited to the tracking methods of inside-out tracking and outside-in tracking, as long as same may be a component capable of tracking the HMD 100.

As a method for identifying the “coordinate Z1”, there is, for example, a method for identifying the “coordinate Z1” in the camera coordinate system by detecting, from the real image, the marker 500 arranged in advance in the real space. Specifically, the position calculation unit 201 identifies the “coordinate Z1” in the camera coordinate system on the basis of the coordinates of the marker 500 in the real space. Since the marker 500 in the real space is stationary, the coordinates of the marker 500 in the real space are always fixed coordinates, even if the user of the HMD 100 moves around. For this reason, the position calculation unit 201 can convert the position of the marker 500 in the “real space” into the camera coordinate system of the HMD 100 on the basis of the position of the marker 500 in the “real image”. In other words, the position calculation unit 201 can learn the “coordinate Z1” in the camera coordinate system from the relative position relationship between the HMD 100 and the marker 500 in the real space.

In addition, the position calculation unit 201 is not limited to the marker 500, as long as it can identify a reference position (reference coordinates) for arranging the virtual image. For this reason, the position calculation unit 201 may identify the coordinates, in the camera coordinate system, of the feature points of an object fixed in the real space.

The rendering unit 202 is a generation unit that generates a virtual image. First, the rendering unit 202 reads content from the content DB 203 according to the position of the “coordinate Z1” detected by the position calculation unit 201. The rendering unit 202 renders the virtual object (CG) on the basis of the read content. There are many types of algorithms for rendering the virtual object, but in the first embodiment, a polygon unit calculation method widely used in the field, known as real-time rendering (hereinafter referred to as “polygon rendering”) is used. Since polygon rendering is a widely known method and is a method executed by a rendering engine, detailed description thereof will be omitted. The processing time of the rendering engine depends on the performance of a GPU (not shown) mounted on the generation device 200 and the content capacity stored in the content DB 203. For this reason, depending on the performance of the GPU and the content capacity, processing may take a long time. If processing takes a long time, the image observed on the HMD 100 will be displayed with a delay, which will bring a sense of discomfort to the user who is experiencing MR while moving his/her head.

The re-projection unit 204 performs re-projection processing of the virtual object so as to eliminate processing delay caused by the rendering unit 202.

A storage medium (storage unit) is built in the log storage unit 205. The log storage unit 205 is a storage control unit that correlates the line-of-sight detection result with information displayed on the display unit 102 when the line-of-sight is detected, and stores them in a storage medium.

The memory 109 and the memory 209 temporarily store the data acquired by each functional unit. The memory 109 and the memory 209 may be non-volatile storage units or volatile storage units.

The interface unit 108 and the interface unit 208 perform data communication between the HMD 100 and the generation device 200 via the interface 300. The communication may be realized either in a wired manner or in a wireless manner.

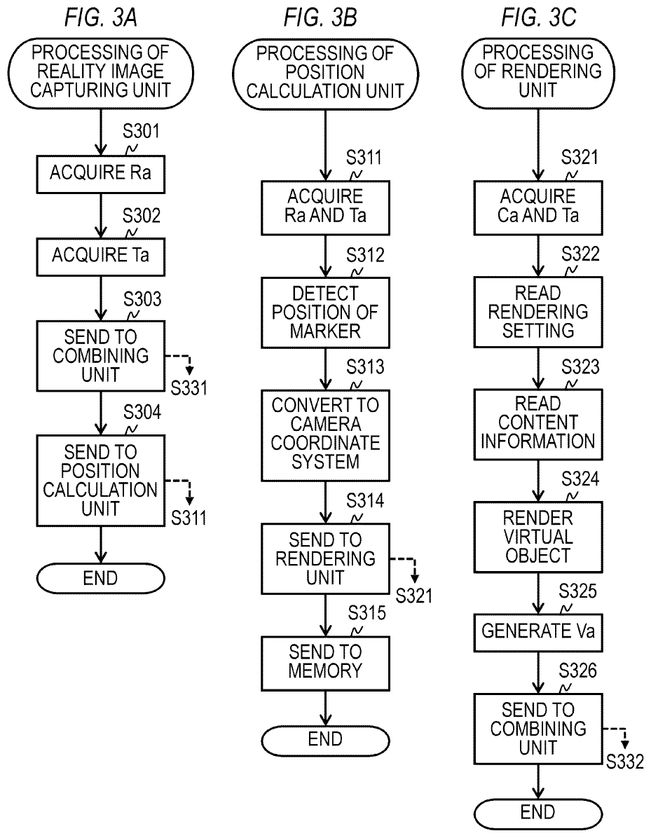

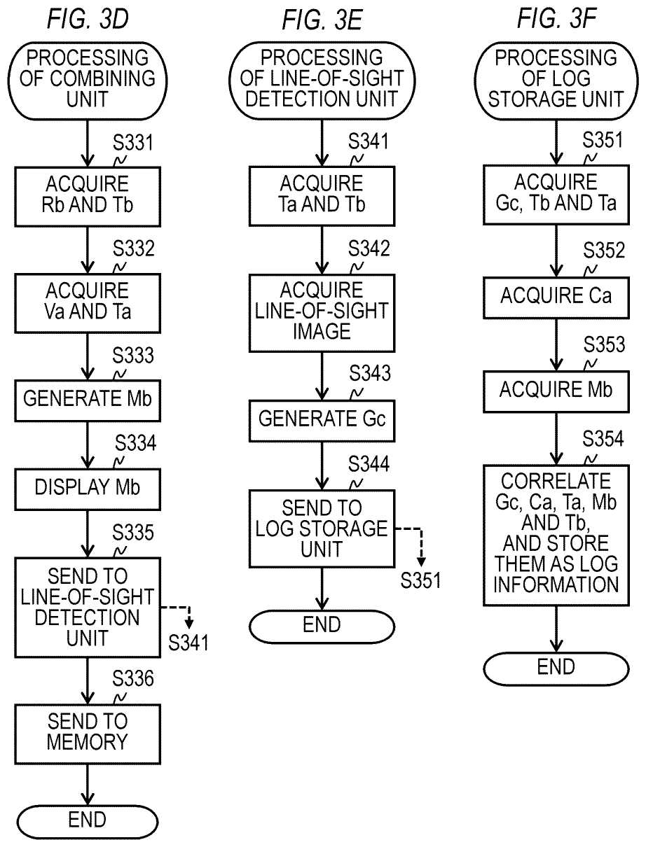

The processing of the first embodiment will be described with reference to the flow charts of FIG. 3A to FIG. 3F. The flow charts of FIG. 3A to FIG. 3F are each independently operated, but some pieces of processing are related. In addition, although each of the flow charts is based on the premise of showing the processing of an image corresponding to one frame, in practice, images are consecutively input as a moving image. For this reason, the processing of this flow chart is continuously carried out, and the processing from the start to the end is repeated each time the image is input.

FIG. 3A is a flow chart showing the processing of the reality image capturing unit 101.

In step S301, the reality image capturing unit 101 captures the real space at a predetermined frame rate to acquire a real image Ra.

In step S302, the reality image capturing unit 101 acquires, from the time detection unit 105, time information Ta indicating the acquisition time (image capturing time) for the real image Ra. The time information Ta is time stamp information issued inside the HMD 100. In the HMD 100, time is managed by means of the time stamp information.

In step S303, the reality image capturing unit 101 sends the real image Ra and the time information Ta to the combining unit 106.

In step S304, the reality image capturing unit 101 sends the real image Ra and the time information Ta to the position calculation unit 201.

FIG. 3B is a flow chart showing the processing of the position calculation unit 201.

In step S311, the position calculation unit 201 acquires the real image Ra acquired at time Ta′ indicated by the time information Ta, together with the time information Ta, from the reality image capturing unit 101.

In step S312, the position calculation unit 201 analyzes the real image Ra to detect (determine) the position of a marker arranged in the real space.

In step S313, the position calculation unit 201 converts the position of the marker to a position in a camera coordinate system. Thus, the position calculation unit 201 can detect a relative position relationship between the HMD 100 and the marker.

In step S314, the position calculation unit 201 sends, to the rendering unit 202, marker position information Ca indicating the position of the marker converted to the camera coordinate system, and the time information Ta.

In step S315, the position calculation unit 201 sends the marker position information Ca and the time information Ta to the memory 209 (stores therein).

FIG. 3C is a flow chart showing the processing of the rendering unit 202.

In step S321, the rendering unit 202 acquires the marker position information Ca and the time information Ta from the position calculation unit 201.

In step S322, the rendering unit 202 reads a rendering setting of a virtual object. The rendering setting is, for example, information indicating the orientation and size of a virtual object to be rendered. The rendering setting depends on an application that executes the rendering. The rendering unit 202 determines, on the basis of the rendering setting, the orientation of the virtual object with respect to the marker at the time of rendering.

In step S323, the rendering unit 202 reads content information from the content DB 203.

In step S324, the rendering unit 202 renders the virtual object on the basis of the content information, the rendering setting, and the marker position information Ca.

In step S325, the rendering unit 202 generates an image representing the rendered virtual object and takes it as a virtual image Va.

In step S326, the rendering unit 202 sends the virtual image Va and the time information Ta (information indicating the image capturing time of the real image for the acquisition of the marker position information Ca) to the combining unit 106.

FIG. 3D is a flow chart showing the processing of the combining unit 106.

In step S331, the combining unit 106 acquires, from the reality image capturing unit 101, the latest real image Rb and time information Tb indicating the acquisition time for the real image Rb. At this time, the time information Tb and the time information Ta indicate different times. This is because the processing in the position calculation unit 201 and the processing in the rendering unit 202 take time. That is to say, there is a difference (time lag) in the reference time between the real image Rb and the virtual image Va. In addition, the difference between time Tb′ indicated by the time information Tb and the time Ta′ indicated by the time information Ta varies depending on the situation.

In step S332, the combining unit 106 acquires the virtual image Va and the time information Ta from the rendering unit 202.

In step S333, the combining unit 106 combines the real image Rb and the virtual image Va to generate an MR image Mb.

In step S334, the combining unit 106 sends the MR image Mb to the display unit 102. As a result, the display unit 102 displays the MR image Mb.

In step S335, the combining unit 106 sends the time information Tb and the time information Ta to the line-of-sight detection unit 103.

In step S336, the combining unit 106 sends the MR image Mb displayed on the display unit 102 and the time information Tb to the memory 209. The MR image Mb and the time information Tb are temporarily stored in the memory 209.

FIG. 3E is a flow chart showing the processing of the line-of-sight detection unit 103.

In step S341, the line-of-sight detection unit 103 acquires, from the combining unit 106, the time information Tb indicating the acquisition time for the real image Rb related to the MR image Mb, and the time information Ta.

In step S342, the line-of-sight detection unit 103 acquires a line-of-sight image obtained by capturing the eyes (pupils) of a user at the point in time when the MR image Mb is displayed on the display unit 102.

In step S343, the line-of-sight detection unit 103 generates, on the basis of the acquired line-of-sight image, a line-of-sight detection result Gc and takes it as input information from the user. The line-of-sight detection result Gc is two-dimensional coordinate information and represents a position (viewpoint position) viewed by the user on the display surface of the display unit 102.

In step S344, the line-of-sight detection unit 103 sends the line-of-sight detection result Gc, the time information Tb and the time information Ta to the log storage unit 205.

FIG. 3F is a flow chart showing the processing of the log storage unit 205.

In step S351, the log storage unit 205 acquires the line-of-sight detection result Gc, the time information Tb and the time information Ta from the line-of-sight detection unit 103. With reference to the time information Ta, the log storage unit 205 can identify the image capturing time of the real image for generating the virtual image Va included in the MR image Mb. With reference to the time information Tb, the log storage unit 205 can identify the image capturing time of the real image included in the MR image Mb.

In step S352, the log storage unit 205 accesses the memory 209 to acquire the marker position information Ca corresponding to the time information Ta.

In step S353, the log storage unit 205 accesses the memory 209 to acquire the MR image Mb corresponding to the time information Tb.

In step S354, the log storage unit 205 correlates the “line-of-sight detection result Gc”, the “marker position information Ca”, the “time information Ta”, the “MR image Mb”, and the “time information Tb” with each other, and stores them in a storage medium as log information.

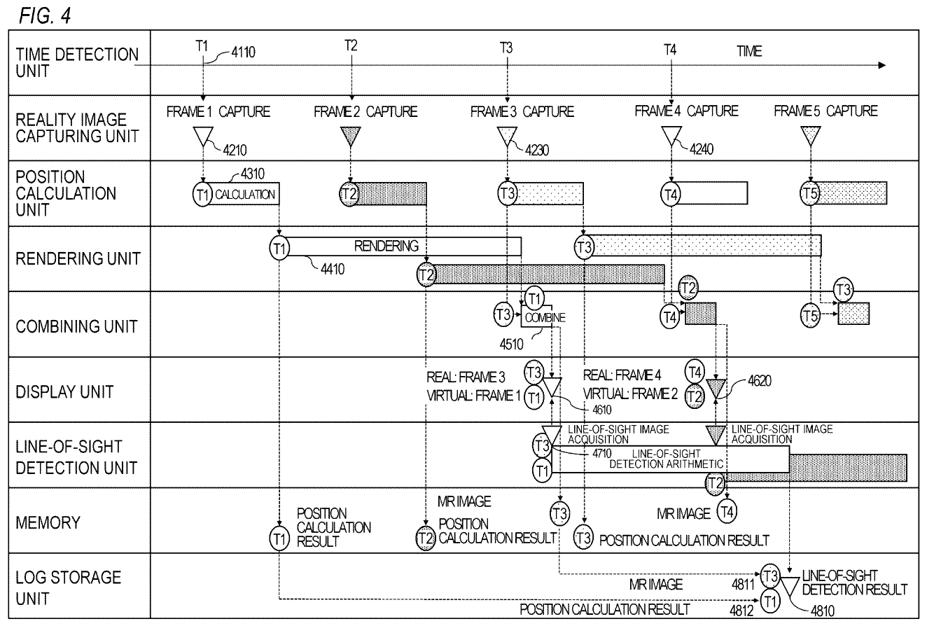

The processing at each time according to the first embodiment will be described with reference to the time chart of FIG. 4. In FIG. 4, the processing of the time detection unit 105, the reality image capturing unit 101, the position calculation unit 201, the rendering unit 202, the combining unit 106, the display unit 102, the line-of-sight detection unit 103, the memory 209, and the log storage unit 205 at each time is described.

At a point in time 4210, the reality image capturing unit 101 captures a real image of frame 1 by capturing the real space.

During a period 4310, the position calculation unit 201 calculates the coordinates (position) of the marker on the basis of the real image that is captured.

During a period 4410, the rendering unit 202 generates a virtual image by rendering a virtual object on the basis of the coordinates (position) of the marker.

During a period 4510, the combining unit 106 generates an MR image by combining the latest real image captured at a point in time 4230 and the virtual image.

At a point in time 4610, the display unit 102 starts to display the MR image generated during the period 4510.

At a point in time 4710, the line-of-sight detection unit 103 acquires a line-of-sight image that is an image of the eyes (pupils) of a user viewing the display unit 102.

At a point in time 4810, the log storage unit 205 acquires (confirms) a line-of-sight detection result indicating the position viewed by the user, as a result of performing line-of-sight detection arithmetic on the detected line-of-sight image. At this time, the MR image that has started to be displayed at a point in time 4620 is displayed on the display unit 102. Each arithmetic processing has a time lag and its delay amount also varies. For this reason, even if only the line-of-sight detection result confirmed at the point in time 4810 is referred to, it is difficult to determine the MR image displayed at which point in time is viewed, or at which point in time are the real image and the virtual image included in the MR image based on the image capturing of the real space.

Then, the log storage unit 205 manages time information at each processing point in time in association, as described with reference to the flow chart of FIG. 3F. Thus, the log storage unit 205 identifies which point in time each piece of information is from. As in step S351 of FIG. 3F, at the point in time 4810, the log storage unit 205 has already acquired that “the MR image is information at time T3, and the position calculation result is information at time T1”. Then, the log storage unit 205 accesses the memory 209 to acquire the MR image associated with the time T3 at a point in time 4811, and to acquire the position calculation result associated with the time T1 at a point in time 4812. Therefore, the log storage unit 205 can appropriately associate the line-of-sight detection result with each piece of acquired information in temporal consistency and store it as log information.

According to such processing, the image capturing time of the real image used for the generation of the virtual image and the image capturing time of the real image used for combining a combined image can be learned from the log information. Based on these image capturing times, the MR image, the position of the marker and the line-of-sight detection result, it is possible to identify with high accuracy whether the user is viewing the virtual image or the real image in the MR image, as well as the object that the user is viewing in the MR image.

According to the first embodiment, time information is issued as a time stamp value, and the time information is managed in association with each piece of acquired information. Thus, even in the case where a time lag occurs between the line-of-sight detection result and each step of processing, the time information can be correlated with each piece of processing with high accuracy. Consequently, since the object or the like to be observed by the user can be identified on the basis of the log information, data can be managed in such a way that processing corresponding to the input information regarding the MR image (display image) can be executed more appropriately.

In the first embodiment, there is one reality image capturing unit that captures the real space, and the image for the generation of the MR image and the image used for position calculation are common. However, the HMD 100 may have a plurality of reality image capturing units. In addition, an optical sensor may be used for position calculation instead of the reality image capturing unit.

Moreover, instead of the line-of-sight detection result according to the line of sight of the user, the result of the user's operation on the MR image may be used as the input information. For example, instead of the line-of-sight detection result, a result of a touch position on a display unit having a touch panel may be used. In addition, instead of the line-of-sight detection result, a gesture detection result indicating a specific position of the MR image may be used.

### Second Embodiment

In the first embodiment, the time detection unit 105 generates the time stamp information for time management and identifies the acquisition time for each piece of data. In the second embodiment, the time detection unit 105 identifies the acquisition time for each piece of data by predicting the time required for processing, rather than generating time stamp information.

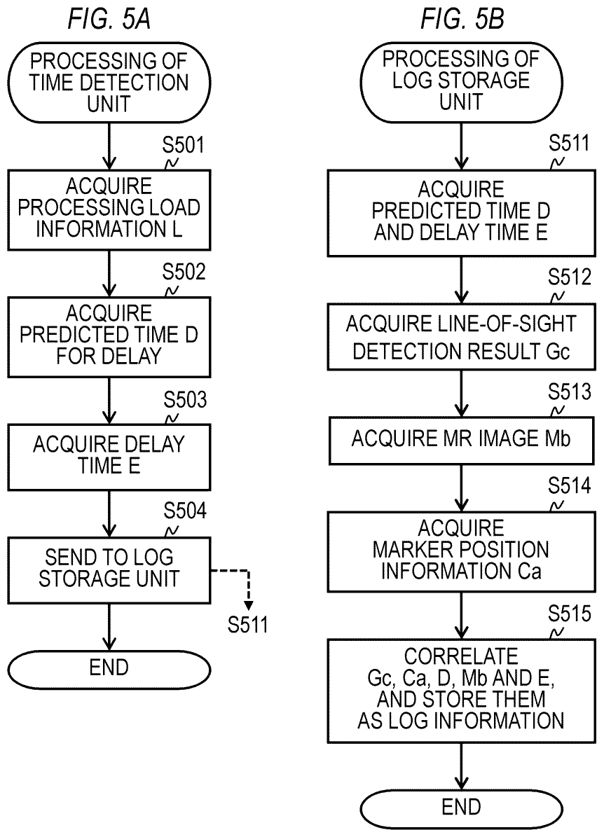

Processing of the second embodiment will be described with reference to the flow charts of FIG. 5A and FIG. 5B. The basic flow is the same as the flow charts in FIG. 3A to FIG. 3F, but different parts will be extracted and described.

FIG. 5A is a flow chart showing the processing of the time detection unit 105.

In step S501, the time detection unit 105 acquires processing load information L from the generation device 200. In components such as the position calculation unit 201 and the rendering unit 202, the processing time is unstable. For example, a data volume of content data (data used for rendering the virtual object) stored in the content DB 203 is considered to be the main cause for the variations in processing time. Thus, in the second embodiment, the processing load information L is the data volume of the content data. In addition, instead of the data volume of the content data, any parameter that causes variations in processing time of the rendering unit 202 and the like, can be used as the processing load information L.

In step S502, the time detection unit 105 determines a predicted time D for delay according to the processing load information L. The predicted time D is the time from the time when the position calculation result of the real image for generating the virtual image is calculated to the time when the MR image Mb in which the virtual image is combined is displayed. In FIG. 4, the predicted time D is the time from when the calculation (determination) of the position of the marker by the position calculation unit 201 is completed (the end of the period 4310=the start of the period 4410) to when the MR image Mb is displayed (the point in time 4610=the point in time 4710) by the display unit 102. The predicted time D is a time measured (estimated) in advance according to the varying value of the processing load information L, and is a value uniquely determined with respect to the processing load information L.

In step S503, the time detection unit 105 acquires information about a delay time E from the line-of-sight detection unit 103. The delay time E is the time from the acquisition time (the display time of the MR image Mb) for the line-of-sight image to the time when the line-of-sight detection result is generated (acquired) from the line-of-sight image. In FIG. 4, the delay time E is the time from the acquisition of the line-of-sight image (the point in time 4710=the point in time 4610) to the end of the line-of-sight detection arithmetic by the line-of-sight detection unit 103 (starting point of the dotted line arrow toward the point in time 4810). The delay time E is a processing time that has been measured in advance, and is a constant value.

In step S504, the time detection unit 105 sends information about the predicted time D for delay and information about the delay time E to the log storage unit 205.

FIG. 5B is a flow chart showing the processing of the log storage unit 205.

In step S511, the log storage unit 205 acquires the information about the predicted time D and the information about the delay time E from the time detection unit 105.

In step S512, the log storage unit 205 acquires the line-of-sight detection result Gc from the line-of-sight detection unit 103.

In step S513, the log storage unit 205 acquires the MR image Mb corresponding to the delay time E from the memory 209. At this time, the log storage unit 205 refers to the data (data generated during the period 4510 in FIG. 4) of the MR image Mb generated the delay time E previously from the timing when the line-of-sight detection result Gc is acquired. For this reason, the log storage unit 205 can identify the acquisition time for the MR image Mb on the basis of the delay time E. Further, since the latest captured image at the time of combining is used for the MR image Mb, the log storage unit 205 can identify, on the basis of the delay time E, the image capturing time of the real image included in the MR image Mb displayed on the display unit 102.

In step S514, the log storage unit 205 acquires the marker position information Ca corresponding to the predicted time D from the memory 209. At this time, the log storage unit 205 refers to the marker position information Ca (data acquired during the period 4310 in FIG. 4) acquired the predicted time D previously from “the timing when the MR image Mb identified in step S513 is stored in the memory 209”. For this reason, the log storage unit 205 can identify the acquisition time for the marker position information Ca on the basis of the total time of the delay time E and the predicted time D. Thus, the log storage unit 205 can identify the image capturing time of the real image for generating the virtual image Va included in the MR image Mb displayed on the display unit 102 because the latest captured image is used for the generation of the virtual image Va at the acquisition time for the marker position information Ca.

In step S515, the log storage unit 205 correlates the “line-of-sight detection result Gc”, the “marker position information Ca”, the information about the “predicted time D”, the “MR image Mb”, and the information about the “delay time E” with each other, and stores them in a storage medium (storage unit) as log information.

In the second embodiment, the time detection unit 105 predicts (estimates) the predicted time D and the delay time E. Then the log storage unit 205 stores the information about the predicted time D, the information about the delay time E, line-of-sight detection information and the MR image as log information. Consequently, since the object or the like to be observed by the user can be identified on the basis of the log information, data can be managed in such a way that processing corresponding to input information regarding the MR image (display image) can be executed more appropriately.

Note that the predicted time D is used to identify the image capturing time of the real image used for generating the virtual image (for determining the position of the marker). For this reason, in a combination of the first and second embodiments, instead of the information about the predicted time D, the time information Ta may be stored by the log storage unit 205. In addition, the time information Ta and the information about the predicted time D are pieces of time information related to the position of the marker (reference position), and instead of the above-mentioned information, for example, information (information at the end point in time of the period 4310 in FIG. 4) about the determination time of the position of the marker may be stored. The time information Tb and the information about the delay time E are pieces of time information related to the real image used for the combining of the MR image, and instead of the above-mentioned information, information about the acquisition time for the combined image using the real image (information at the end point in time of the period 4510 in FIG. 4) may be stored.

### Third Embodiment

In the third embodiment, the operation when the re-projection unit 204 performs re-projection processing of the virtual image will be described.

In the case where the processing of the position calculation unit 201, the rendering unit 202, and the like takes a lot of time, the re-projection unit 204 converts the image so as to eliminate the movement of the HMD 100 during that time. As a result, the re-projection unit 204 reduces the display delay of an image that occurs due to the processing time.

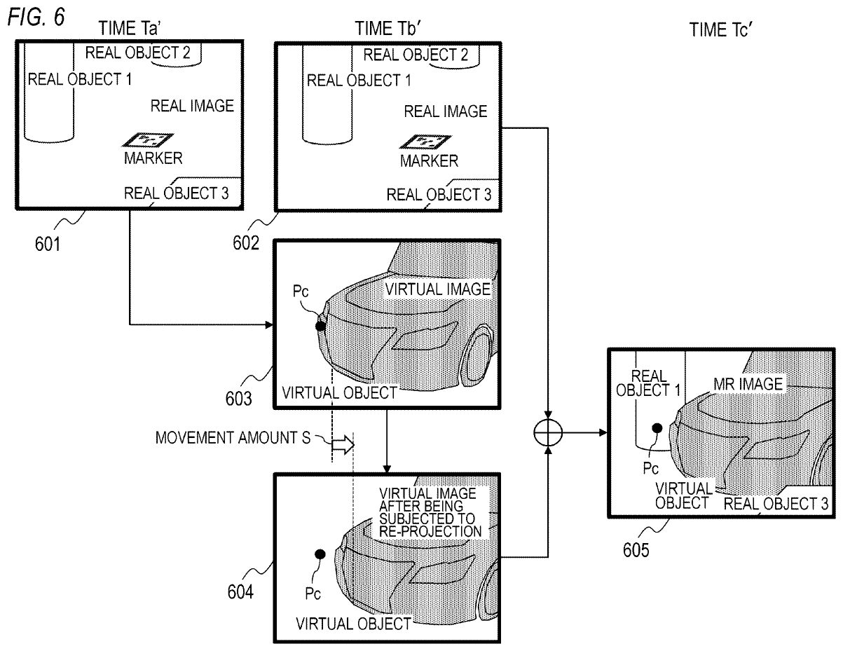

FIG. 6 is a diagram for explaining the third embodiment. An image 601 is a real image acquired by the reality image capturing unit 101 at the time Ta′ indicated by the time information Ta. The real image 601 shows a real image in which real objects 1 to 3 and a marker are captured. An image 603 is a virtual image in which the rendering unit 202 arranges a virtual object on the basis of the result of the detection of the marker shown in the real image 601. At this time, since rendering takes time, it is assumed that the generation of the virtual image is completed at the time Tb′ (time Tb′ indicated by the time information Tb), which is later than the time Ta′.

An image 602 is a real image acquired (captured) by the reality image capturing unit 101 at the time Tb′. As shown in the real image 602, the position of the marker in the real image has moved to the right due to the movement of the HMD 100 from the time Ta′ to the time Tb′. The re-projection unit 204 obtains a movement amount S of the marker (amount of movement of the HMD 100) during a period between the two times on the basis of the marker position supplied from the position calculation unit 201. The re-projection unit 204 performs re-projection processing on the basis of the movement amount S to change the position of the virtual object. An image 604 is a virtual image in which a virtual object after being subjected to the re-projection processing is arranged. In the virtual image 604, it can be seen that the virtual object has only moved by the movement amount S from the state shown in the virtual image 603.

An image 605 shows an MR image in which the real image 602 and the virtual image 604 are combined. By combining in this way, on the basis of the processing time between the time Ta′ and the time Tb′, the virtual image is corrected so that the virtual object moves in the direction opposite to the movement direction of the HMD 100. Therefore, it is difficult for the user to notice the influence on the virtual image due to the processing delay.

Here, the problem when both the processing of the re-projection unit 204 and the processing of the log storage unit 205 are executed will be described. A position Pc is the position viewed by the user at time Tc′ when the MR image shown in the image 605 is displayed. In the first and second embodiments, the virtual image correlated with the position Pc is the virtual image 603, but the virtual image 603 is a virtual image before re-projection processing is executed. Therefore, the user is not actually viewing the object projected at the position Pc in the virtual image 603. Therefore, since the virtual object has actually moved by the movement amount S, it is necessary to store the log information in consideration of the movement amount S.

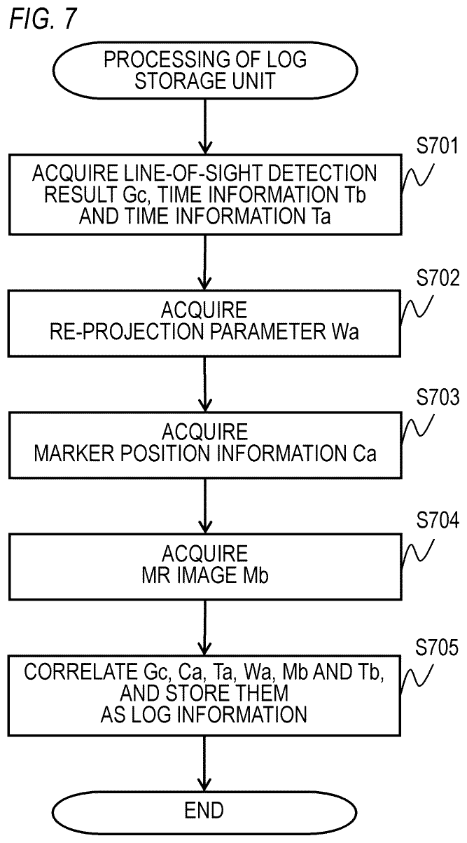

FIG. 7 is a flow chart showing the processing of the log storage unit 205 in the third embodiment.

In step S701, processing similar to that in step S351 is performed.

In step S702, the log storage unit 205 acquires, from the re-projection unit 204, a re-projection parameter Wa of the virtual image at the time Ta′ indicated by the time information Ta. The re-projection parameter Wa is a parameter used for re-projection processing, and is a parameter corresponding to a movement vector of the marker (=movement of the HMD 100) during the time between the time Ta′ and the time Tb′. The re-projection parameter Wa is, for example, a parameter such as a vector indicating the amount and direction of movement of the virtual object in the re-projection processing. The re-projection parameter Wa may include not only parameters of the movement in the two-dimensional image but also parameters of the homography transformation matrix or parameters of three-dimensional movement changes.

In step S703, processing similar to that in step S352 of FIG. 3F is performed.

In step S704, processing similar to that in step S353 of FIG. 3F is performed.

In step S705, the log storage unit 205 correlates the “line-of-sight detection result Gc”, the “marker position information Ca”, the “time information Ta”, the “re-projection parameter Wa”, the “MR image Mb”, and the “time information Tb” with each other, and stores them in a storage medium as log information.

In the third embodiment, the log storage unit 205 stores log information including the re-projection parameter used by the re-projection unit 204. Thus, even in the case where a virtual object moves according to the movement of the HMD 100, input information (line-of-sight detection information) and other data can be correlated with high accuracy.

In addition, in the above description, the expression “in a case where A is equal to or larger than B, the process goes to step S1, and in a case where A is smaller than (lower than) B, the process goes to step S2” may be replaced with the expression “in a case where A is greater (higher) than B, the process goes to step S1, and in a case where A is equal to or smaller than B, the process goes to step S2”. Conversely, the expression “in a case where A is greater (higher) than B, the process goes to step S1, and in a case where A is equal to or smaller than B, the process goes to step S2” may be replaced with the expression “in a case where A is equal to or larger than B, the process goes to step S1, and in a case where A is smaller than (lower than) B, the process goes to step S2”. For this reason, unless contradiction is caused, the expression “equal to or larger than A” may be replaced with “larger (higher; longer; or more) than A”, and the expression “equal to or smaller than A” may be replaced with “smaller (lower, shorter, or less) than A”. Then, the expression “larger (higher, longer, or more) than A” may be replaced with the expression “equal to or larger than A”, and the expression “smaller (lower; shorter; or less) than A” may be replaced with the expression “equal to or smaller than A”.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to manage data in such a way that processing corresponding to input information regarding a display image can be executed more appropriately

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-161002, filed Sep. 18, 2024, which is hereby incorporated by reference herein in its entirety.

What is claimed is:

1. An information processing system comprising one or more processors and/or circuitry configured to:
execute generation processing for generating a virtual image by rendering a virtual object based on a reference position determined at a first time;
execute combining processing for generating a display image by combining the virtual image and a first image;
execute display control processing for displaying the display image on a display at a second time;
execute input processing for acquiring input information from a user for the display at the second time; and
execute control processing in which the input information, the display image, information about the reference position, first piece of information which is time information related to the reference position, and second piece of information which is time information related to the first image, are correlated with each other and stored in a storage device.

2. The information processing system according to claim 1, comprising an image sensor configured to acquire the first image by capturing a real space at a third time, which is later than the first time.

3. The information processing system according to claim 2, wherein
the image sensor is configured to acquire a second image obtained by capturing the real space at a fourth time, which is earlier than the first time, and
the one or more processors and/or circuitry are configured to execute determination processing for determining, based on the second image, the reference position at the first time.

4. The information processing system according to claim 3, wherein
the virtual image is an image obtained by performing re-projection processing of the virtual object based on a movement of the image sensor between the fourth time and the third time,
in the combining processing, the display image is generated by combining the virtual image and the first image, and
in the control processing, information related to the re-projection processing, the input information, the display image, the information about the reference position, the first piece of information and the second piece of information are correlated with each other and stored in the storage device.

5. The information processing system according to claim 3, wherein the first piece of information is information indicating the fourth time.

6. The information processing system according to claim 2, wherein the second piece of information is information indicating the third time.

7. The information processing system according to claim 1, wherein in the input processing, the input information is acquired at a fifth time; and
the second piece of information indicates a time between the second time and the fifth time.

8. The information processing system according to claim 7, wherein the first piece of information indicates a time between the second time and the first time.

9. The information processing system according to claim 8, wherein the first piece of information indicates a time between the second time and the first time estimated based on a data volume of content data used for the generation of the virtual image.

10. The information processing system according to claim 1, wherein in the input processing, information related to a line of sight of the user, obtained based on an image capturing the eyes of the user, is acquired as the input information.

11. A control method of an information processing system comprising:
generating a virtual image by rendering a virtual object based on a reference position determined at a first time;
generating a display image by combining the virtual image and a first image;
displaying the display image on a display at a second time;
acquiring input information from a user for the display at the second time; and
executing control processing in which the input information, the display image, information about the reference position, first piece of information which is time information related to the reference position, and second piece of information which is time information related to the first image, are correlated with each other and stored in a storage device.

12. A non-transitory computer readable medium that stores a program, wherein the program causes a computer to execute a control method of an information processing system comprising:
generating a virtual image by rendering a virtual object based on a reference position determined at a first time;
generating a display image by combining the virtual image and a first image;
displaying the display image on a display at a second time;
acquiring input information from a user for the display at the second time; and
executing control processing in which the input information, the display image, information about the reference position, first piece of information which is time information related to the reference position, and second piece of information which is time information related to the first image, are correlated with each other and stored in a storage device.
